(19) United States
(12) Patent Application Publication
(10) Pub. No.: US 2005/0063881 A1
(43) Pub. Date: Mar. 24, 2005

(54) Air purifier including a photocatalyst

(76) Inventors: Dennis R. Senne, Palm Coast, FL (US); Stuart Engel, Cote St Luc (CA)

Correspondence Address: MARC A. VIVENZIO;LORUSSO LOUD & KELLY LLP, SUITE 312, 15 RYE STREET, PORTSMOUTH, NH, 03801, US

(21) Appl. No.: 10/903,587

(22) Filed: Jul. 30, 2004

Related U.S. Application Data
(60) Provisional application No. 60/490,923, filed on Jul. 30, 2003.

(51) Int. Cl. B01J 19/08

(52) U.S. Cl. 422/186.3

(57) ABSTRACT

A purification system includes a treatment chamber provided with an inlet and an outlet and defining an interior surface. A radiation source is provided within the treatment chamber. A photocatalytic reactor purifying the fluid upon receiving radiation emitted from the radiation source is also provided within the purification system. The interior surface of the treatment chamber is substantially reflective for radiation emitted by the radiation source.

### FIELD OF THE INVENTION

The present invention relates to an air purifier used to purify air from chemical and biological air contaminants.

### BACKGROUND OF THE INVENTION

Indoor air quality problems, often referred to as “sick building syndrome” costs North America well over 100 billion dollars each year in health care, absenteeism, lost production time and lost revenue. Studies have demonstrated that the air inside businesses and homes can be more contaminated than the outside air of some industrialized cities.

It is well known that the purification of air within a ventilation system with filters having pores of approximately 0.3 microns is very efficient to remove various particulates in certain cases in the air circulating within the ventilation system. Also, it is known that irradiating air circulating within the ventilation system with ultraviolet light having certain wavelengths also has a decontaminating effect.

Yet another known method for purifying air includes illuminating a surface impregnated with titanium dioxide with ultraviolet light. However, to be efficient, this method requires that the titanium dioxide impregnated surface includes a large irradiated surface. Also, the titanium dioxide must be tightly bound to the surface to resist vibrations commonly present within ventilation systems.

Space constraints within ventilation systems typically prevent the use of large linear surface areas. Compounding this problem, large surface areas achieved by folding or otherwise compacting a large surface are typically hard to irradiate efficiently with ultraviolet light. More details regarding contaminants typically found inside ventilation systems can be found in U.S. Pat. No. 5,833,740, which is hereby incorporated by reference in its entirety.

### OBJECTS OF THE INVENTION

An object of the present invention is therefore to provide an improved air purifier.

### SUMMARY OF THE INVENTION

More specifically, in accordance with the present invention, there is provided a purification system for a fluid. The purification system includes a treatment chamber, including an inlet and an outlet. The treatment chamber defines an interior surface. A radiation source is provided within the treatment chamber. A photocatalytic reactor purifying the fluid upon receiving radiation emitted from a radiation source is also provided within the purification system. The interior surface is substantially reflective for radiation emitted by the radiation source.

In another broad aspect, the invention provides the photocatalytic reactor for mounting within the purification system for a fluid. The purification system includes an ultraviolet radiation source to irradiate the photocatalytic reactor. The reactor includes a body defining a reaction surface, the reaction surface including a photocatalytic material. The photocatalytic material includes an organic-solvent-based substrate adhering to the body and a titanium dioxide powder mixed with the substrate.

In yet another broad aspect, the invention provides a method for purifying a fluid, the method including providing a treatment chamber defining an interior surface, the interior surface being substantially reflective to radiation having a wavelength selected from a set of predetermined wavelengths. Furthermore, the method includes providing a flow of fluid to purify within the treatment chamber and providing a catalyzer within the treatment chamber, the catalyzer being activated by radiation having a wavelength from the set of predetermined wavelengths. The method further includes providing a photocatalytic reactor within the treatment chamber, the photocatalytic reactor purifying the fluid in response to receiving at least part of the catalyzer activating radiation. Also, the method includes reflecting the radiation from the interior surface toward the photocatalytic reactor.

In yet another broad aspect, the invention provides a purification system for a fluid, the purification system including irradiating means for emitting radiation, reflecting means substantially reflective to radiation emitted by the irradiating means. Furthermore, the purification system includes a photocatalytic means for purifying the fluid upon receiving radiation emitted from the irradiating means. The irradiating means, the reflecting means and the photocatalytic means are positioned such that the irradiating means irradiates the photocatalytic means both directly without any reflection and through reflection of radiation emitted by the irradiating means unto the reflecting means.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1 is a perspective view of purification system for a fluid according to a first embodiment of the present invention;

FIG. 2 is a longitudinal cross-sectional view taken along line 2-2 of FIG. 1;

FIG. 3 is a transversal cross-sectional view taken along line 3-3 of FIG. 1;

FIG. 4 is a longitudinal cross-sectional view similar to view of FIG. 2, illustrating a purification system according to a second embodiment of the present invention;

FIG. 5 is a longitudinal cross-sectional view similar to the view of FIG. 2, illustrating an air purifier according to a third embodiment of the present invention; and

FIG. 6 illustrates a specific embodiment of a photocatalytic reactor.

### DETAILED DESCRIPTION

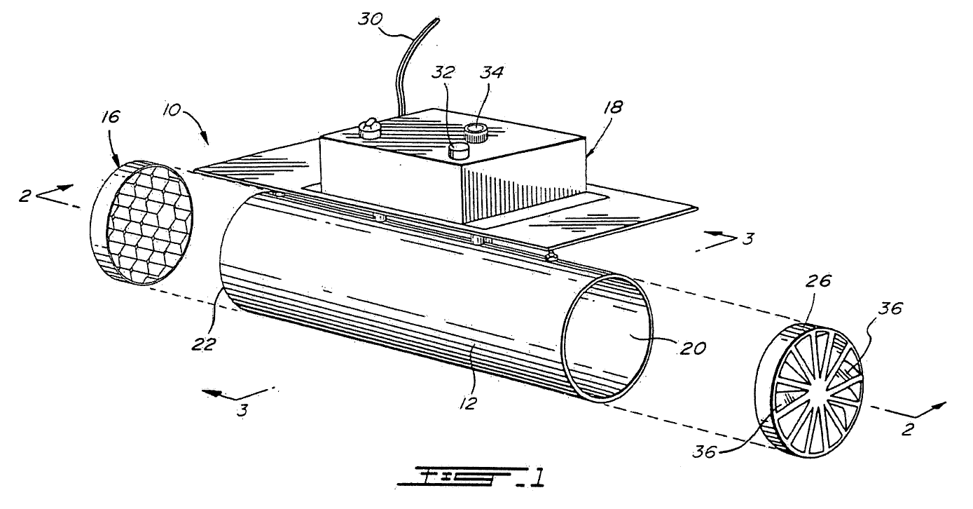

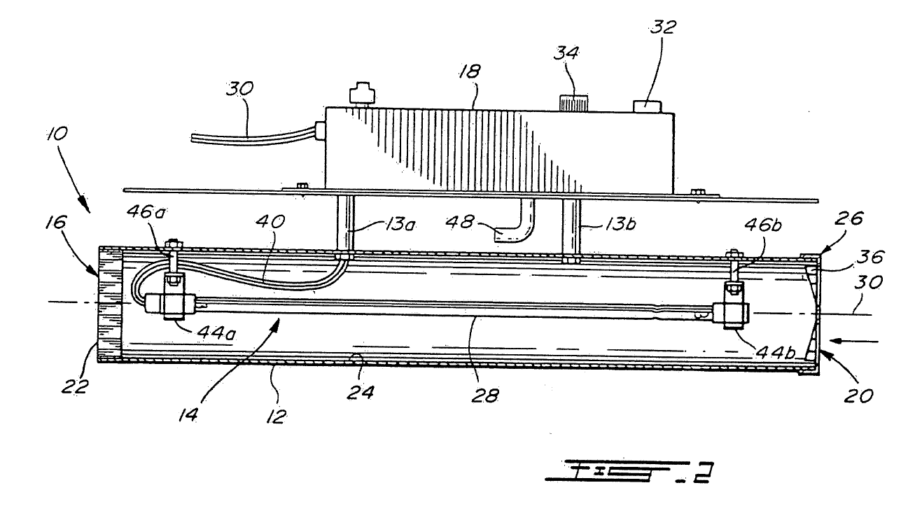

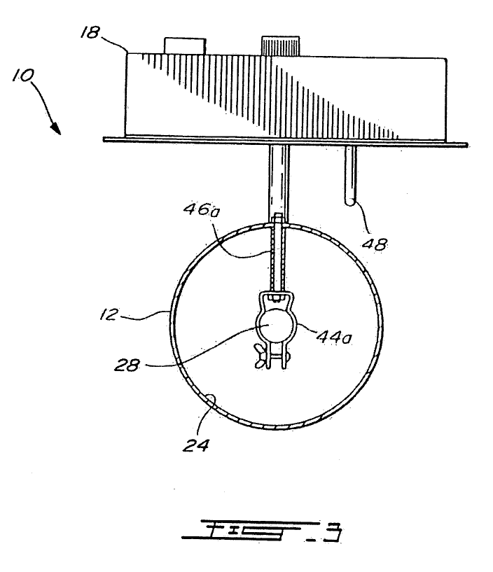

FIGS. 1 to 3 illustrate a purification system 10 for fluid according to a first embodiment of the present invention. The purification system 10 includes a treatment chamber 12, a radiation source 14 (see FIGS. 2 and 3), a photocatalytic reactor 16 and a controller 18. The radiation source 14 is provided within the treatment chamber 12. The photocatalytic reactor 16 is located such that radiation emitted by the radiation source 14 irradiates the photocatalytic reactor 16.

The purification system 10 allows performing a method for purifying a fluid, the method including providing a treatment chamber defining an interior surface, the interior surface being substantially reflective to radiation having a wavelength selected from a set of predetermined wavelengths. Furthermore, the method includes providing a flow of fluid to be purified within the treatment chamber and providing a catalyzer within the treatment chamber, the catalyzer being activated by radiation having a wavelength from the set of predetermined wavelengths. The method further includes providing a photocatalytic reactor within the treatment chamber, the photocatalytic reactor purifying the fluid in response to receiving at least part of the catalyzer-activating radiation. Also, the method includes reflecting the radiation from the interior surface toward the photocatalytic reactor.

In other words, the invention provides a purification system for a fluid, the purification system including irradiating means for emitting radiation, reflecting means substantially reflective to radiation emitted by the irradiating means. Furthermore, the purification system includes a photocatalytic means for purifying the fluid upon receiving radiation emitted from the irradiating means. The irradiating means, the reflecting means and the photocatalytic means are positioned such that the irradiating means irradiates the photocatalytic means both directly without any reflection and through reflection of radiation emitted by the irradiating means unto the reflecting means.

In the first specific embodiment of the invention shown in FIGS. 1 to 3, the treatment chamber 12 is substantially cylindrical. However, it is within the scope of the invention to have treatment chambers having any other suitable shape.

The treatment chamber 12 defines an inlet 20, an outlet 22 and an interior surface 24. The inlet and the outlet 20 and 22 are provided each at opposite ends of the treatment chamber 12. The inlet and the outlet respectively receive and eject the fluid to be purified from the treatment chamber 12.

The interior surface 24 is substantially reflective for radiation emitted by the radiation source 14. Therefore, radiation emitted by the radiation source 14 is able to reach the photocatalytic reactor 16 both directly and through reflection onto the interior surface 24.

The interior surface 24 illustrated herein includes an aluminum polished surface. However, it is within the scope of the invention to have any suitable reflecting surface, including among others, any polished metal surface suitable to reflect the radiation emitted by the source 14. Alternatively, the reflective surface 24 includes a reflective coating reflecting the radiation emitted by the radiation source 14. A turbulence generator 26 provided at the inlet 20 generates turbulence of the fluid entering the treatment chamber 12. Therefore, the fluid does not flow smoothly within the purification system 10 and a dwell is created within the treatment chamber 12. This increases the residence duration of the fluid within the system, and therefore increases the efficiency of the purification system 10. The turbulence generator may be passive as illustrated herein or an active device that is controllable by the controller 18.

The turbulence generator 26 includes baffles 36 provided at the inlet 20. More details regarding the turbulence generator 26, which can take the form of a fan in some embodiments of the invention, are found in above-cited U.S. Pat. No. 5,833,740.

Advantageously, the reflective surface allows radiation emitted by the radiation source to reach the photocatalytic reactor even if the radiation is not emitted directly towards the photocatalytic reactor. In addition, since light emitted by the radiation source travels within the treatment chamber in a plurality of directions having different angles, a photocatalytic reactor presenting a reaction surface oriented substantially parallel to the radiation source is illuminated more thoroughly by the radiation.

In the purification system 10, the radiation source 14 takes the form of a dual zone mercury vapor lamp 28. The mercury vapor lamp 28 is provided within the treatment chamber 12 and emits both photons in a wavelength range varying from about 170 to about 220 nm, and in another wavelength range varying from about 220 to about 288 nm. The effect of ultraviolet photons having wavelengths between 170 nanometers and 288 nanometers is described in further details in the above-cited U.S. Pat. No. 5,833,740 and will not be repeated herein for concision purpose. However, in other embodiments of the invention the lamp 28 emits photons in a single wavelength selected from any suitable range of wavelengths to react with the photocatalytic reactor 16.

In a specific embodiment of the invention, as described hereinabove, the lamp 28 emits radiation including radiation having a wavelength of about 254 nanometers. In addition, radiation having a wavelength of about 254 nanometers has been found to be suitable for stimulating the photocatalytic reactor such that air passing therethrough is purified. This is especially the case for a photocatalytic reactor including titanium dioxide as will be described in further details hereinbelow.

The cylindrical treatment chamber 12 defines a longitudinal axis 30. In addition, the lamp 28 includes a substantially elongated portion substantially parallel to the longitudinal axis 30.

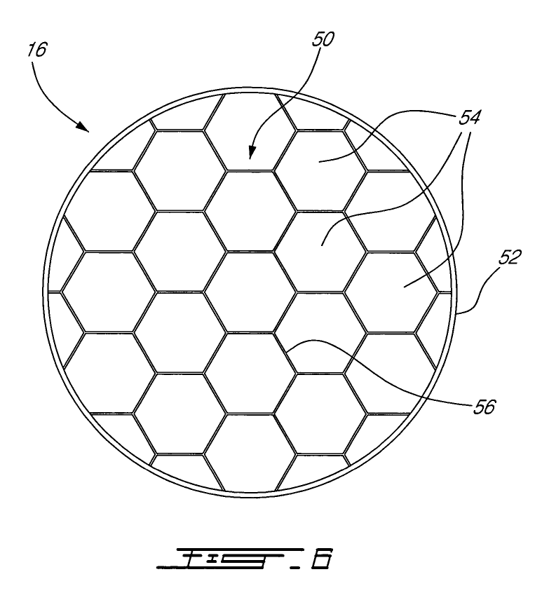

The photocatalytic reactor 16 is provided in the proximity of the outlet 22. As shown in FIG. 6, the photocatalytic reactor 16 includes a body 50 provided within a frame 52.

The frame 52 is designed to be mounted to the treatment chamber 12 and therefore has a circular profile, as shown in the appended figures.

Of course, the frame of the photocatalytic reactor 16 could have other profiles such as, for example, a square profile. Indeed, square profiles are typically more easily manufactured than circular profiles.

The body 50 includes a honeycomb structure defining a plurality of cells 54 oriented substantially parallel to the longitudinal axis of the treatment chamber 12 when installed therein. Therefore, air circulating within the photocatalytic reactor 16 does not create a significant backpressure into the ventilation system 10. The cells 54 each define a surface 56 including a photocatalytic material. The body 50 includes any suitable material, such as aluminum, steel, plastic and ceramics, among others.

In specific embodiments of the invention, the photocatalytic material includes a coating present onto a least part of the surface 56. The coating includes titanium dioxide in powder form and a substrate into which the titanium dioxide is dispersed. In other embodiments of the invention, the coating includes titanium dioxide in any suitable form, or any suitable photocatalytic material.

An example of a specific titanium dioxide powder suitable for use with the present invention includes grains having a surface area of between about 35 and about 65 square meters per gram. Also, a substrate suitable for use with the present invention is substantially transparent to part of the radiation emitted by the radiation source 14.

The photocatalytic material includes between about 50% by weight and about 75% by weight of titanium dioxide, although other proportions are within the scope of the invention. Therefore, when no other components than titanium dioxide and the substrate included in the coating, the coating includes between about 25% to about 50% by weight of the substrate.

A substrate suitable for use with the present invention includes Toluene, VM and P Naphtha, Hexane, Xylene, Acetone, Ethyl Benzene and Fumed Amorphous Silica in relative proportions of about 29.8: about 24.7: about 10.6: about 9.0: about 5.8: about 2.3: about 1.1 by weight.

In alternative embodiments of the invention, the photocatalytic material includes an organic-solvent-based substrate adhering to the body 50 and a titanium dioxide powder mixed with the substrate. In specific embodiments, the body 50 includes a metal and a substrate, the substrate including a metal paint. The substrate being substantially transparent to at least some ultraviolet radiation wavelengths. Since titanium dioxide is particularly photoactive to wavelengths of about 254 nanometers, in some embodiments of the invention a substrate transparent to radiation having a wavelength of about 254 nanometers is particularly suitable.

As better shown in FIGS. 2 and 3, the lamp 28 is supported within the treatment chamber 12 by two support rods 46a and 46b, each being connected to a respective clamp 44a and 44b. The treatment chamber 12 is mounted to the controller via two posts 13a and 13b. A power cable 30 supplies electric power to the controller and a power cable 40 interconnects the controller 18 and the tube 28. The controller 18 also includes an on/off switch 32 and a pilot light 34.

The controller 18 includes a ballast circuit (not shown) for powering the lamp 28 and controls the operation of the purification system 10 as follows. The exact structure of the controller 18 is not described in details herein as the reader skilled in the art will readily appreciate how such a structure can be built to achieve the intended results.

In use, the controller 18 allows a user to control the activation of the radiation source 14. In some embodiments of the invention, the radiation source 14 is continuously activated. In other embodiments of the invention, the controller 18 intermittently activates the radiation source 28. In yet other embodiments, the controller 18 activates the radiation source 28 only when a pressure difference between the interior and the exterior of the treatment chamber 12 is detected a pressure sensor 48.

When the radiation source 14 is in operation, air entering the treatment chamber 12 through the inlet 20 is first purified by the radiation emitted by the radiation source 14. Such purification is described in further detail in the above referenced U.S. Pat. No. 5,833,740.

The reflective internal surface 24 of the treatment chamber 12 greatly improves the efficiency of purification provided by the radiation source 14 as radiation reflected within the treatment chamber 12 passes through the fluid to purify many times, thereby increasing greatly a length of a path through which the radiation interacts with the fluid. Before the fluid reaches the outlet 22, it enters the photocatalytic reactor 16.

In the photocatalytic reactor 16, the ultraviolet light frees electrons from the titanium dioxide, which cause the coating to become very reactive, particularly to organic compounds. Therefore, organic molecules present in the fluid react with the coating and are broken down into simpler molecules, such as water and carbon dioxide, among others.

It has been found that It has been found that UV generating assemblies such as the R3500X and the UV Bio-Wall, both made by Sanuvox Technologies Inc., Montreal, Quebec, Canada have been found adequate to be used in the present invention

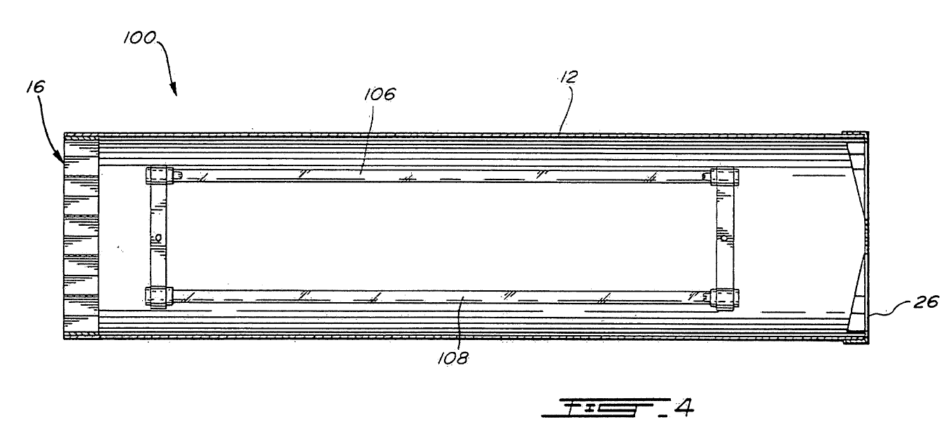

Turning now to FIG. 4 of the appended drawings, a purification system 100 according to a second embodiment of the present invention will be described. The purification system 100 is very similar to the purification system 10 shown on FIGS. 1 to 3, with a major difference that the dual zone mercury vapor lamp 28 of the purification system 10 has been replaced by two mercury vapor lamps 106 and 108 acting as the radiation source 14. The lamps 106 and 108 both emit photons having a wavelength between 220 and 288 nm, in particular at 254 nm. One skilled in the art will understand that only one lamp could be used.

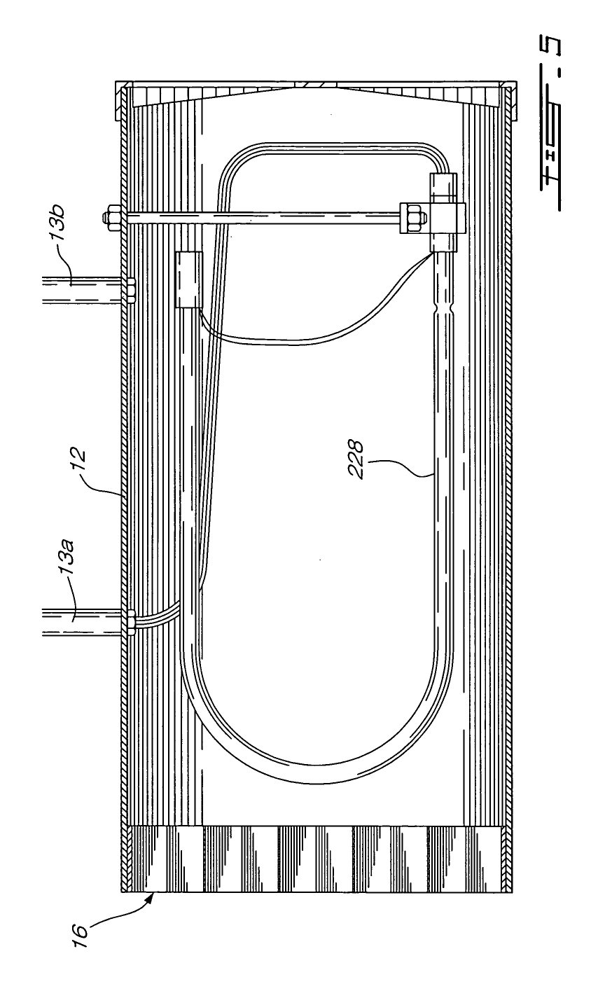

Turning to FIG. 5, there is shown another purification system 200 similar to the purification system 10 shown on FIGS. 1 to 3, with a major difference that the dual zone mercury vapor lamp 28 of the purification system 10 has been replaced by a J-shaped dual zone mercury vapor lamp 228.

As will be understood by the reader skilled in the art, a purification system according to the present invention may be installed in an air return plenum of any existing ventilation system, air conditioning unit or heating system. More specifically, the in-duct version illustrated in the appended drawings may be installed In the air return plenum just before the circulation fan, before the air filter, for residential use and in the air return plenum, between the last return duct and the circulation fan, for commercial use.

The air purifier of the present invention may also, in some cases, be installed in the supply side of the system.

Although the present invention has been described hereinabove by way of preferred embodiments thereof, it can be modified, without departing from the spirit and nature of the subject invention as defined in the appended claims.

### REFERENCES

U.S. Pat. No. 5,833,740 issued Nov. 10, 1998 to Normand Brais.

1. A purification system for a fluid comprising:
a treatment chamber including an inlet and an outlet, said treatment chamber defining an interior surface;
a radiation source provided within said treatment chamber; and
a photocatalytic reactor purifying the fluid upon receiving radiation emitted from said radiation source;
wherein said interior surface is substantially reflective for radiation emitted by said radiation source.

2. A purification system as defined in claim 1, wherein said reflecting surface includes a polished metal surface.

3. A purification system as defined in claim 2, wherein said metal includes aluminum.

4. A purification system as defined in claim 1, wherein said reflecting surface includes a reflective coating.

5. A purification system as defined in claim 1, wherein said photocatalytic reactor includes a body defining a reaction surface, said reaction surface including a photocatalytic material.

6. A purification system as defined in claim 5, wherein said photocatalytic material includes a coating applied onto at least part of said body.

7. A purification system as defined in claim 6, wherein said coating includes titanium dioxide.

8. A purification system as defined in claim 7, wherein said coating includes a substrate into which said titanium dioxide is dispersed, said titanium dioxide being in powder form.

9. A purification system as defined in claim 8, wherein said powder includes grain having a surface area of between about 35 and about 65 square meters per gram.

10. A purification system as defined in claim 8, wherein said substrate is substantially transparent to radiation emitted by said radiation source.

11. A purification system as defined in claim 8, wherein said coating includes between about 50% by weight and about 75% by weight of titanium dioxide.

12. A purification system as defined in claim 8, wherein said substrate includes Toluene, VM and P Naphtha, Hexane, Xylene, Acetone, Ethyl Benzene and Fumed Amorphous Silica in relative proportions of about 29.8: about 24.7: about 10.6: about 9.0: about 5.8: about 2.3: about 1.1 by weight.

13. A purification system as defined in claim 8, wherein said coating includes about 50% by weight of said substrate.

14. A purification system as defined in claim 7, wherein radiation emitted by said radiation source includes radiation having a wavelength of about 254 nanometer.

15. A purification system as defined in claim 7, wherein said radiation emitted by said radiation source includes UV photons having a wavelength in a range of about 220 to about 288 nanometres.

16. A purification system as defined in claim 7, wherein said radiation emitted by said radiation source includes UV photons having a wavelength in a range of about 170 to about 220 nanometres.

17. A purification system as defined in claim 6, wherein said body includes a honeycomb structure defining a plurality of substantially hexagonal cells, each cell defining a respective internal surface, said coating being applied on at least part of said internal surfaces.

18. A purification system as defined in claim 6, wherein said photocatalytic reactor further includes a frame located peripherally to said body.

19. A purification system as defined in claim 1, wherein said photocatalytic reactor is provided in proximity to said outlet.

20. A purification system as defined in claim 19, wherein said treatment chamber further includes a turbulence generator mounted in proximity of said inlet.

21. A purification system as defined in claim 20, wherein said treatment chamber is substantially cylindrical.

22. A purification system as defined in claim 1, wherein said treatment chamber defines a longitudinal axis, and wherein said radiation source includes a substantially elongated portion substantially parallel to said longitudinal axis.

23. A photocatalytic reactor for mounting within a purification system for a fluid, the purification system including an ultraviolet radiation source to irradiate said photocatalytic reactor, said reactor comprising a body defining a reaction surface, said reaction surface including a photocatalytic material, said photocatalytic material including:
an organic-solvent-based substrate adhering to said body; and
a titanium dioxide powder mixed with said organic-solvent-based susbtrate.

24. A photocatalytic reactor as defined in claim 23, wherein said body includes a metal; and said substrate includes a metal paint.

25. A photocatalytic reactor as defined in claim 24, wherein said substrate is substantially transparent to at least some ultraviolet radiation.

26. A photocatalytic reactor as defined in claim 25, wherein said substrate is substantially transparent to radiation having a wavelength of 254 nanometers.

27. A photocatalytic reactor as defined in claim 23, wherein said coating includes between about 50% by weight and about 75% by weight of titanium dioxide.

28. A photocatalytic reactor as defined in claim 23, wherein said substrate includes toluene, VM and P naphtha, hexane, xylene, acetone, ethyl benzene and fumed amorphous silica in relative proportions of about 29.8: about 24.7: about 10.6: about 9.0: about 5.8: about 2.3: about 1.1 by weight.

29. A purification system as defined in claim 23, wherein said body includes a honeycomb structure defining a plurality of substantially hexagonal cells, each cell defining a respective internal surface.

30. A method for purifying a fluid, said method comprising the steps of:
providing a treatment chamber defining an interior surface, the interior surface being substantially reflective to radiation having a wavelength selected from a set of predetermined wavelengths;
providing a flow of fluid to purify within the treatment chamber;
providing a catalyser-activating radiation within the treatment chamber, the catalyser-activating radiation having a wavelength from the set of predetermined wavelengths;
providing a photocatalytic reactor within the treatment chamber, the photocatalytic reactor purifying the fluid in response to receiving at least part of the catalyser-activating radiation; and
reflecting the radiation from the interior surface towards the photocatalytic reactor.
